(19) United States
(12) Patent Application Publication
(10) Pub. No.: US 2007/0247833 A1
(43) Pub. Date: Oct. 25, 2007

(54) Backlight unit for liquid crystal display

(75) Inventors: Hyun Ho Lee, Suwon (KR); Hun Joo Hahm, Sungnam (KR); Hyung Suk Kim, Suwon (KR); Hyeong Won Yun, Yongin (KR); Yoon Tak Yang, Hwasung (KR); Myoung Bo Park, Seocheon-gun (KR); Chul Hee Yoo, Suwon (KR); Sang Yun Lee, Suwon (KR); Jae Wook Kwon, Seoul (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 11/785,449

(22) Filed: Apr. 18, 2007

(30) Foreign Application Priority Data
Apr. 19, 2006 (KR) 10-2006-0035493

(51) Int. Cl. G09F 13/04

(52) U.S. Cl. 362/97

(57) ABSTRACT

A backlight unit suitable for realizing a high-quality image. The backlight unit according to the present invention is a direct type, which is disposed under a liquid crystal panel to irradiate light to a back surface of the liquid crystal panel. The backlight unit includes a light source unit having a plurality of light source regions formed on a substrate, each of the light source regions driven separately and having at least one light emitting diode. The backlight unit also includes partitions provided on the substrate and disposed between the light source regions of the light source unit, and a circuit for controlling and driving the light source unit.

### CLAIM OF PRIORITY

This application claims the benefit of Korean Patent Application No. 2006-0035493 filed on Apr. 19, 2006, in the Korean Intellectual Property Office, the disclosure of which is incorporated herein by reference.

### BACKGROUND OF THE INVENTION

1. Field of the Invention

The present invention relates to a backlight unit for a liquid crystal display and, more particularly, to a direct type backlight unit, which partially drives a light source by divided regions to effectively adjust a light distribution, thereby allowing a clear image with high contrast.

2. Description of the Related Art

With recent trend of miniaturization and high functionality of image display devices, liquid crystal displays are used extensively for televisions, monitors, and the like. As a liquid crystal panel is not capable of emitting light on its own, the liquid crystal display requires a separate light source unit, i.e., a backlight unit (hereinafter, “BLU”). In general, Cold Cathode Fluorescent Lamps (CCFLs), which are low cost with easier assembly, have been used as the light source for BLU. However, the BLU using CCFL has drawbacks like environmental pollution, slow response rate and difficulty in partial driving. In order to overcome such problems, Light Emitting Diodes (LEDs) have been suggested as the light source of BLU instead of the CCFL. The BLU using LED can complement the drawbacks of the conventional CCFLs, and in particular, enables partial driving such as local dimming or impulsive driving.

In general, a BLU is divided into a direct type BLU (direct method) and an edge type BLU (side method). The edge type has a bar-shaped light source disposed at a side of a liquid crystal panel, irradiating light through a light guide panel toward the liquid crystal panel. On the other hand, the direct type BLU irradiates light directly to the liquid crystal panel from a surface light source disposed under the liquid crystal panel.

To produce a livelier image, the liquid crystal panel of the liquid crystal display is divided into a plurality of regions, and according to the gray level value of each of the regions, the luminance value of the BLU light source can be adjusted by each of the divided regions. Such BLU driving method is referred to as “local dimming.” That is, the LEDs in the BLU region corresponding to a bright portion of the display are turned on while other LEDs corresponding to the rest of the panel can be turned on at lower luminance or turned off. According to the local dimming method, the bright part can be brighter or the dark part can be darker, resulting in a livelier image. On the other hand, the impulsive driving method synchronizes the BLU with the liquid crystal panel in time. According to the impulsive driving, the plurality of light source regions, which are arranged in parallel on a BLU substrate, are turned on sequentially.

FIG. 1 is a sectional view illustrating a liquid crystal display having a direct type BLU according to the prior art. Referring to FIG. 1, the liquid crystal display 50 includes a liquid crystal panel 17, a BLU 10 and a plurality of optical sheets 15, for example, diffusion plates, disposed between the liquid crystal panel 17 and the BLU 10. The BLU 10 includes a BLU substrate 11, a plurality of red, green and blue LEDs 13 disposed on the BLU substrate 11. On the BLU substrate 11, a circuit 12 is installed for driving and controlling the LEDs.

FIG. 2 shows the above BLU 10 driven by a partial (regional) driving method such as local dimming or impulsive driving, in which FIG. 2(a) shows the light and shade distribution of the liquid crystal panel, FIG. 2(b) shows the lighting status of the BLU, and FIG. 2(c) shows the luminance distribution above the BLU. As shown in FIG. 2(a), when the liquid crystal panel 17 exhibits a light and shade distribution (or image signal distribution) with distinction between a dark region 17a and a bright region 17b, the LEDs on the BLU substrate 11 can be driven separately by the regions. For example, only the LEDs 13b in a particular region A can be turned on while the LEDs 13a in other regions can be turned off (see FIG. 2(b)).

However, in spite of such partial driving of the BLU, the luminance distribution above the BLU is not clearly distinguished by region. That is, as shown in FIG. 2(c), the luminance distribution of the BLU includes a low-luminance region 27a corresponding to the dark region 17a, a high-luminance region 27b corresponding to the bright region 17b, and middle regions 27c with graded luminance between the high and low-luminance regions. As shown in FIG. 3, even if only the LEDs in region A are turned on, the light amount distribution above the diffusion plate 15a disposed above the BLU is not clearly distinguished between the low luminance region and the high-luminance region, and exhibits graded areas between the high and low-luminance regions. If the light amount distribution is not distinguished by regions as intended by the partial driving such as local dimming, the effects of partial driving (clear and lively image quality and synchronization between the BLU and the liquid crystal panel in time) cannot be expected.

### SUMMARY OF THE INVENTION

The present invention has been made to solve the foregoing problems of the prior art and therefore an aspect of the present invention is to provide a high quality backlight unit which drives a light source by a partial driving method such as local dimming, impulsive driving, etc., thereby adjusting a luminance distribution with clear distinction among divided regions of a liquid crystal panel.

According to an aspect of the invention, the invention provides a direct type backlight unit used to irradiate light to a back surface of a liquid crystal panel of a liquid crystal display. The backlight unit includes a light source unit having a plurality of light source regions formed on a substrate, each of the light source regions driven separately and having at least one LED; partitions provided on the substrate and disposed between the light source regions of the light source unit; and a circuit for controlling and driving the light source unit.

According to an embodiment of the present invention, the LED in each of the light source regions of the light source unit includes at least one of each of red, green and blue LEDs. According to another embodiment of the present invention, each of the light source regions of the light source unit comprises at least one white LED.

According to an embodiment of the present invention, the liquid crystal panel has a plurality of divided regions, and wherein each of the light source regions of the light source unit irradiates light to corresponding one of the divided regions of the liquid crystal panel.

In order to realize local dimming method, the luminance of the light source may be controlled by adjusting the luminance of each of the light source regions according to a gray level peak value of each of the divided regions of the liquid crystal panel. In this case, the circuit may include a controller and an LED driver. The controller controls the operation of the LED driver in accordance with the gray level peak value of each of the divided regions of the liquid crystal panel, and the LED driver drives the light source unit in accordance with control by the controller such that at least one of the light source regions have different luminance from other ones of the light source regions.

To realize the impulsive driving, the light source regions may extend in a horizontal direction, and may be lighted sequentially by being synchronized in time with the liquid crystal panel.

According to an embodiment of the present invention, the partitions may extend in a horizontal or vertical direction on the substrate. In addition, the partitions may be arranged in a matrix on the substrate. According to an embodiment of the present invention, the partitions have a height of 5 to 25 mm.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a sectional view illustrating a liquid crystal display with a backlight unit according to the prior art;

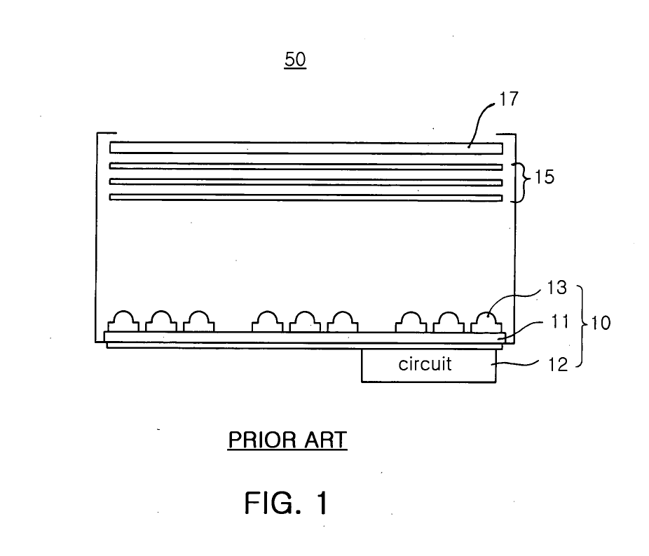

FIG. 2 illustrates the conventional backlight unit, in which FIG. 2(a) shows the light and shade distribution of a liquid crystal panel, FIG. 2(b) shows the lighting status of the backlight unit, and FIG. 2(c) shows the luminance distribution of the backlight unit;

FIG. 3 is a view illustrating the light amount distribution curve of the conventional backlight unit;

FIG. 4 is a sectional view illustrating a backlight unit according to an embodiment of the present invention;

FIG. 5 is a view showing the light amount distribution curve of the backlight unit according to an embodiment of the present invention;

FIG. 6 is a plan view illustrating exemplary forms of the partitions according to various embodiments of the present invention;

FIG. 7 is a view showing the light amount distribution according to the height of the partition;

FIG. 8 is a view schematically showing the luminance distribution above the backlight unit according to the present invention; and

FIG. 9 is a configuration view illustrating a liquid crystal display with the backlight unit according to an embodiment of the present invention.

### DETAILED DESCRIPTION OF THE PREFERRED EMBODIMENT

Exemplary embodiments of the present invention will now be described in detail with reference to the accompanying drawings. The invention may however be embodied in many different forms and should not be construed as limited to the embodiments set forth herein. Rather, the embodiments are provided so that this disclosure will be thorough and complete, and will fully convey the scope of the invention to those skilled in the art. In the drawings, the shapes and dimensions may be exaggerated for clarity, and the same or similar components are designated by the same reference numerals throughout.

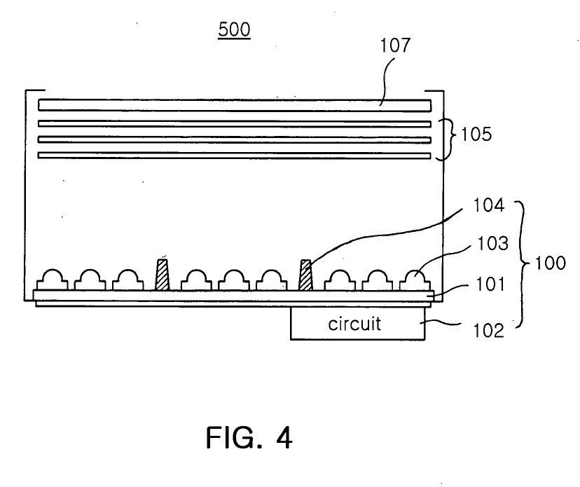

FIG. 4 is a sectional view illustrating a liquid crystal display having a Backlight Unit (BLU) according to an embodiment of the present invention. Referring to FIG. 4, the liquid crystal display 500 includes a liquid crystal panel 107, a BLU 100 and an optical sheet 105 disposed between the display and the BLU. The BLU 100 is a direct type, which is disposed under the liquid crystal panel 107 to irradiate light to the back surface of the liquid crystal panel 107. The BLU 100 includes a plurality of LEDs 103 and a circuit 102 for driving and controlling the LEDs. The plurality of LEDs 103 are disposed on the substrate 101 and constitute a light source unit of the BLU (the arrangement of the plurality of LEDs 103 on the substrate 101 is referred to as “LED light source unit”).

The LED light source unit is divided into a plurality of light source regions A1, A2 and A3, and each of the light source regions A1, A2 and A3 includes at least one LED. For example, each of the light source regions A1, A2 and A3 can have at least one of each of red, green and blue LEDs. Using a set of the red, green and blue LEDs allows emission of white light with superior color reproducibility. In another embodiment, each of the light source unit regions A1, A2 and A3 can have at least one white LED. The white LED can be obtained, for example, by using a blue LED chip with yellow phosphor.

In addition, the LED light source unit can be driven partially by the light source regions. For example, only the LEDs in a light source region A2 can be turned on while the LEDs in other light source regions A1 and A3 can be turned off or turned on at lower luminance. This partial driving method can be applied to implement local dimming or impulsive driving as described later.

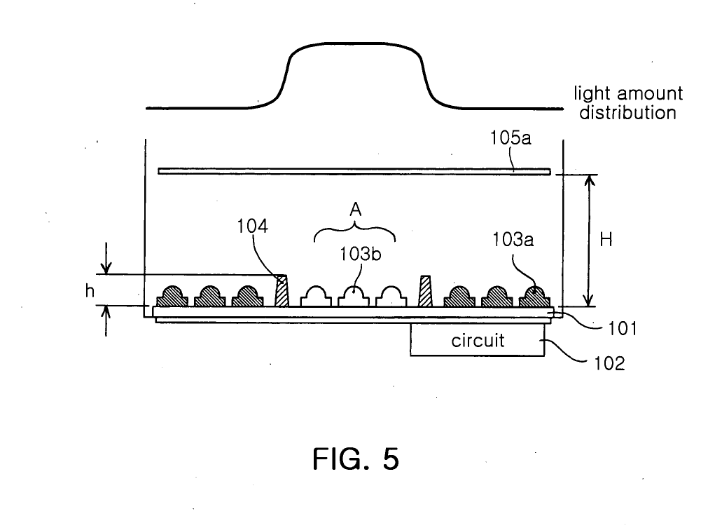

As shown in FIG. 4, partitions 104 are formed on the substrate 101. These partitions 104 are disposed at the boundaries between the light source regions A1, A2 and A3. The partitions 104 serve to block the light, emitted from each of the light source regions A1, A2 and A3, from entering other regions. In particular, the sideward light emitted from each of the light source regions is reflected or absorbed by the partitions 104, thus minimally affecting other light source regions as possible. Therefore, the luminance distribution of the BLU 100 is more clearly distinguished among the light source regions. Such a feature is clearly shown in FIG. 5.

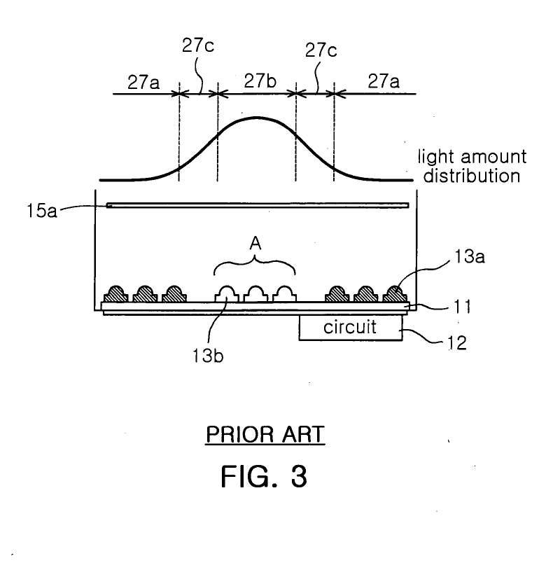

FIG. 5 schematically illustrates the light amount distribution curve of the BLU 100. The light amount distribution on the diffusion plate 105a disposed over the BLU 100 is relatively clearly distinguished between the high-luminance region (the central portion in FIG. 5) and the low-luminance regions (the left and right portions in FIG. 5) (compare with FIG. 3). That is, as the partitions 104 are installed at the boundaries between the light source regions, the light distribution above the BLU (or the diffusion plate) is more clearly distinguished among the regions. This allows accurately confining and lighting only a desired portion of the entire back surface of the liquid crystal panel.

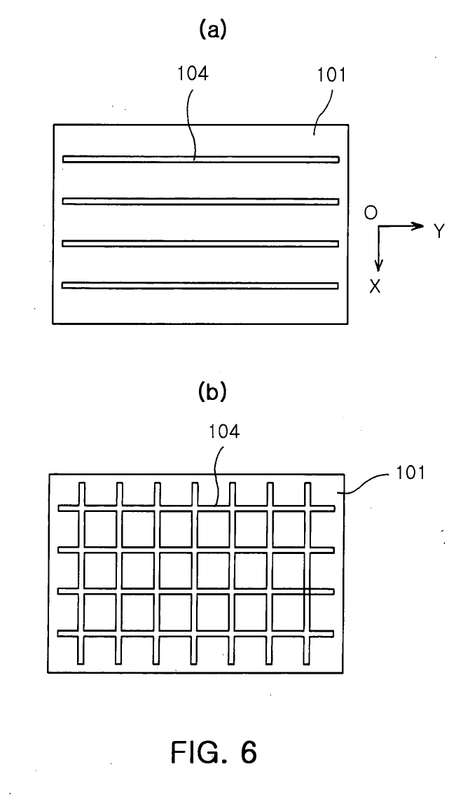

FIG. 6 is a plan view illustrating the arrangement of the partitions according to various embodiments of the present invention. As shown in FIG. 6(a), the plurality of partitions 104 can extend in a horizontal direction (Y-axis direction), in parallel with each other. This partition arrangement is useful especially for driving LEDs through the impulsive driving method. Alternatively, the plurality of partitions can extend in a vertical direction (X-axis direction), in parallel with each other (not shown).

Alternatively, as shown in FIG. 6(b), the partitions 104 can be arranged in a matrix on the substrate 101. In this case, each of the regions on the substrate divided by the partitions 104 (i.e., the regions surrounded by the partitions 104) may correspond to one of the light source regions A1, A2 and A3 (FIG. 4) driven separately. This kind of partition arrangement can be useful especially for driving the LEDs through the local dimming method. The partitions can be arranged variously other than the examples shown in FIG. 6. For example, the partitions can be arranged in a honeycomb, forming hexagonal cells (not shown).

The light distribution above the BLU can vary according to the height h of the partitions and the height H of the BLU (H: distance from the substrate 101 to the diffusion plate 105a) With a greater height h of the partition and a lower height H of the BLU, the light distribution on the diffusion plate 105a is more clearly distinguished by the regions. If the height of the partition is too low, the effect of distinction among the regions due to the partitions decreases. Conversely, if the height of the partition is too high, the effect of clear distinction in the light distribution increases but a greater amount of light is absorbed by the partition, and in turn, the liquid crystal display may have a large overall thickness.

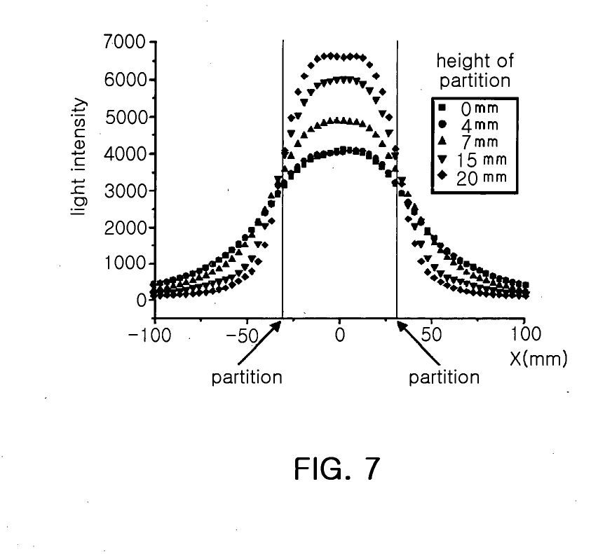

FIG. 7 is a view illustrating the light intensity distribution above the BLU according to the height of the partitions. As shown in FIG. 7, the higher the partition is, the clearer the distinction in the light intensity distribution among the regions. That is, with higher partitions, the light intensity in the area above the BLU corresponding to the lighted light source region A2 becomes higher, and the light intensity in the area above the BLU (left and right parts in FIG. 7) corresponding to the unlighted (or of low luminance) light source regions A1 and A3 becomes lower. Considering the light distribution distinction effects and the light absorption by the partitions, it is preferable that the partition 104 has a height of 5 to 25 mm. However, if the BLU has varying thicknesses, the height of the partition 104 can be adjusted differently.

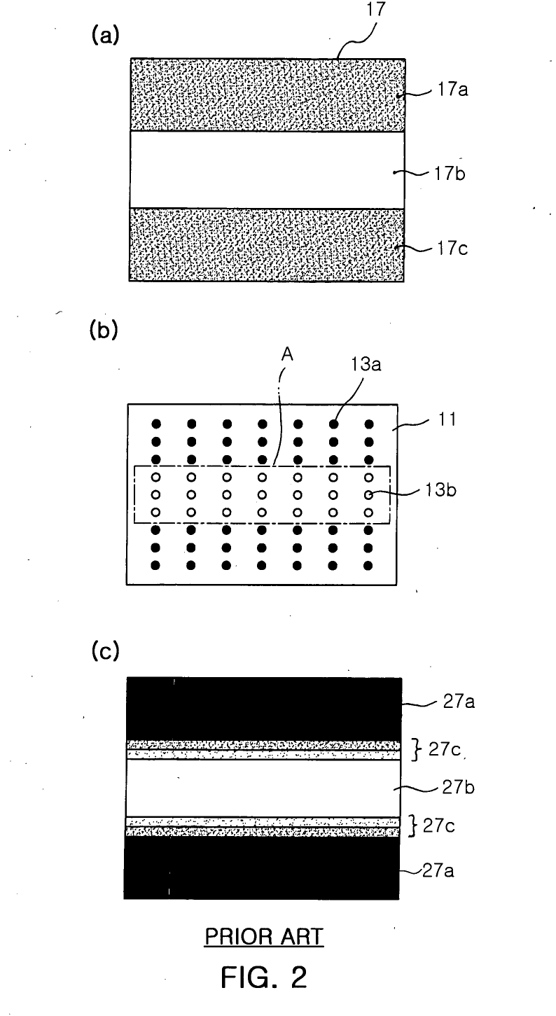

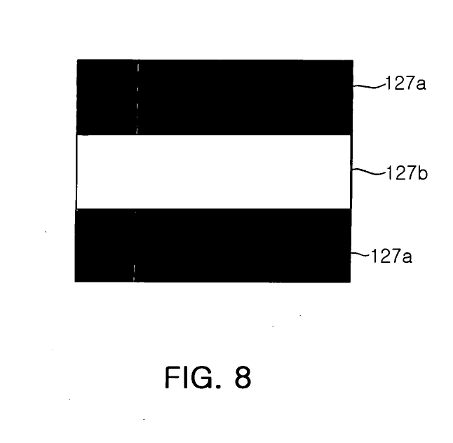

FIG. 8 is a view schematically showing the luminance distribution above the BLU 100. As shown in FIG. 8, among the light source regions A1, A2, A3, the portion on the BLU 100 corresponding to the lighted light source region A2 forms a high-luminance region 127b, whereas the portions on the BLU 100 corresponding to the unlighted light source regions A1 and A3 form low-luminance regions 127a. The high-luminance region 127b and the low-luminance region 127a are distinguished clearly, and they do not have intermediate luminance regions therebetween (compare with FIG. 2(c)).

As shown in FIGS. 5 to 8, the light distribution above the BLU 100 (the light distribution on the diffusion plate 105a) has a profile that is distinguished by the regions. The light distribution clearly distinguished by the regions allows a more effective partial driving method, and more significant effects (clear and lively image, the synchronization between the BLU and the liquid crystal panel in time, etc.) intended by such partial driving method.

The BLU according to the present invention is suitable especially for local dimming or impulsive driving methods. In these methods, the liquid crystal panel has a plurality of divided regions, and the LED light source unit irradiates light separately to the divided regions of the liquid crystal display. For example, referring to FIG. 4, each of the light source regions A1, A2 and A3 of the LED light source unit can irradiate light to corresponding one of the divided regions of the liquid crystal display. In the local dimming method, the luminance of each of the light source regions can be controlled according to the gray level peak value of each of the divided regions. In the impulsive driving method, a plurality of light source regions divided by the partitions 104 can be synchronized in time with the divided regions of the liquid crystal panel, allowing sequential lighting.

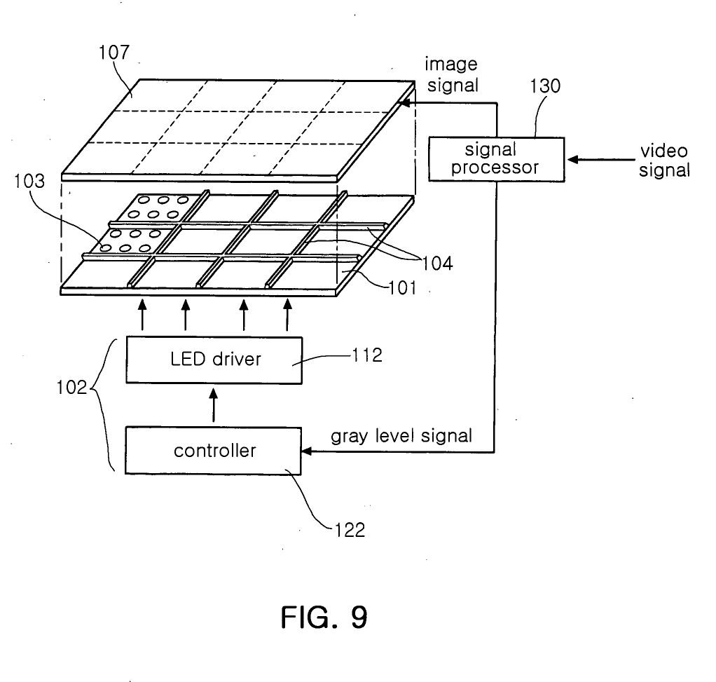

FIG. 9 is a view illustrating a liquid crystal display having the BLU according to an embodiment of the present invention. In this embodiment, the BLU is driven by the local dimming method. Referring to FIG. 9, a plurality of LEDs 103 arranged on the substrate 101 irradiate light to the back surface of the liquid crystal panel 107 (for convenience, the optical sheet is not shown). The plurality of the LEDs 103, i.e., the LED light source unit is divided into a plurality of light source regions driven separately, and partitions 104 are disposed at the boundaries between the plurality of light source regions.

The liquid crystal panel 107 is divided into a plurality of regions (the divided regions are indicated by the dotted lines), which produces images, respectively. The LED light source unit irradiates light separately to the divided regions of the liquid crystal panel 107. At this time, the luminance of each of the light source regions (of the LED light source unit) is adjusted according to the gray level peak value of each of the divided regions (of the liquid crystal panel). That is, the light source region corresponding to one of the divided regions, which should have relatively higher luminance, is lighted with a higher current duty radio than other light source regions. Alternatively, the duty ratio of the light source regions corresponding to the other divided regions can be lowered.

The operation of the BLU by the local dimming is explained with reference to FIG. 9.

When a video signal is inputted to a signal processor 130, the signal processor 130 supplies an image signal for driving each pixel of the liquid crystal panel. In addition, the signal processor 130 processes the video signal to generate a gray level signal for each of the divided regions of the liquid crystal panel 107. The gray level signal is supplied to a controller 122 of the circuit 102. The gray level signal can be the gray level peak value of each of the divided regions.

The controller 122 controls the operation of the LED driver 112 inside the circuit 102 according to the gray level signal. The LED driver 112 drives the LED light source unit in accordance with the control of the controller 122 such that at least some of the light source regions have different luminance from other light source regions. Each of the light source regions of the LED light source unit operates to exhibit the luminance corresponding to each of the gray level peak values. With this method, the luminance of each of the light source regions can be adjusted according to the gray level peak value of each of the divided regions of the liquid crystal panel.

Using such local dimming method allows increasing the contrast ratio of the display while achieving a lively image. In particular, as the partitions are installed at the boundaries of the light source regions, the luminance distribution of the BLU is more clearly distinguished among the regions. This in turn further maximizes the effects of local dimming method and reduces unnecessary light loss.

According to the present invention as set forth above, partitions are installed between light source regions partially driven, thereby allowing a light distribution of the BLU, which is clearly distinguished by the light source regions. This in turn allows more effective matching of the BLU with a liquid crystal panel, reducing unnecessary light loss. Furthermore, accurately confining and lighting only a portion of the liquid crystal panel allows a higher contrast ratio, a clearer image, and further enhanced image quality. Moreover, this allows obtaining a desired form of luminance distribution according to the shape or the structure of the partitions.

While the present invention has been shown and described in connection with the exemplary embodiments, it will be apparent to those skilled in the art that modifications and variations can be made without departing from the spirit and scope of the invention as defined by the appended claims.

What is claimed is:

1. A direct type backlight unit used to irradiate light to a back surface of a liquid crystal panel of a liquid crystal display, comprising:
a light source unit having a plurality of light source regions formed on a substrate, each of the light source regions driven separately and having at least one light emitting diode;
partitions provided on the substrate and disposed between the light source regions of the light source unit; and
a circuit for controlling and driving the light source unit.

2. The backlight unit according to claim 1, wherein the light emitting diode in each of the light source regions of the light source unit comprises at least one of each of red, green and blue light emitting diodes.

3. The backlight unit according to claim 1, wherein each of the light source regions of the light source unit comprises at least one white light emitting diode.

4. The backlight unit according to claim 1, wherein the liquid crystal panel has a plurality of divided regions, and wherein each of the light source regions of the light source unit irradiates light to corresponding one of the divided regions of the liquid crystal panel.

5. The backlight unit according to claim 4, wherein the luminance of the light source unit is controlled by adjusting the luminance of each of the light source regions according to a gray level peak value of each of the divided regions of the liquid crystal panel.

6. The backlight unit according to claim 5, wherein the circuit comprises a controller and a light emitting diode driver, wherein the controller controls the operation of the light emitting diode driver in accordance with the gray level peak value of each of the divided regions of the liquid crystal panel, and the light emitting diode driver drives the light source unit in accordance with control by the controller such that at least one of the light source regions have different luminance from other ones of the light source regions.

7. The backlight unit according to claim 1, wherein the light source regions extend in a horizontal direction, and lighted sequentially by being synchronized in time with the liquid crystal panel.

8. The backlight unit according to claim 1, wherein the partitions extend in a horizontal or vertical direction on the substrate.

9. The backlight unit according to claim 1, wherein the partitions are arranged in a matrix on the substrate.

10. The backlight unit according to claim 1, wherein the partitions have a height of 5 to 25 mm.
